(19) United States
(12) Patent Application Publication
(10) Pub. No.: US 2009/0297950 A1
(43) Pub. Date: Dec. 3, 2009

(54) Lithium battery

(75) Inventors: Fenggang Zhao, Dongguan (CN); Xueze Wang, Dongguan (CN); Kunging Zhu, Dongguan (CN)

Correspondence Address: Dongguan Amperex Technology Co., Ltd., P.O. Box 166-13, Taipei, 115, TW

(73) Assignee: Dongguan Amperex Technology Co., Ltd.

(21) Appl. No.: 12/155,146

(22) Filed: May 30, 2008

(51) Int. Cl. H01M 4/00

(52) U.S. Cl. 429/221; 429/223

(57) ABSTRACT

The present invention is to provide a lithium iron battery includes cathode films, each having an accumulation structure added with activated materials, anode films, and electrolysis liquid. In that, an activated material (i.e. lithium phosphate based cathode added with lithium-nickel-cobalt-manganese mixed metal oxide) has a voltage plateau larger than the lithium phosphate applied to the cathode.

### FIELD OF THE INVENTION

The present invention is related to a lithium phosphate (LiFePo₄) based cathode of a lithium battery; particularly, said cathode has, at least, an activated material (i.e. lithium phosphate based cathode added with lithium-nickel-cobalt-manganese mixed metal oxide) has a higher voltage plateau compared with that of lithium phosphate.

### BACKGROUND OF THE INVENTION

Since 1990, lithium battery initially developed by Sony corporation; the same has been modified and improved hugely in decades. It is predicted that up to 1.871 billion cellular phones and 0.293 billion lap-tops will be powered by lithium ion packs before AD 2017. Due to development of advanced electronic equipments, in a world overwhelmed by small-size, light-weight, and portable electronic devices; which must be ensured by high capacity density batteries with reliable safety.

Lithium phosphate used as an activated material for charging batteries, which can be operated under high temperature, and has a prolonged life cycle and a cheaper prices compared with other cathode activated material. Thus, lithium phosphate based activated material applied to batteries were widely in use for years. However, due to itself characteristic, when the charging procedure is closed to be completed, even the capacity of the battery, which lithium phosphate (LiFePo₄) based as cathode activated material, is just slightly promoted, the voltage of the battery, can be rapidly raised.

On the other hand, requirements of working voltages applied to certain electronic equipments, for example, to afford lap-top computers, power tools with stable voltages, lithium ion batteries are often arrayed in series-parallel connection. When connected in series, all operating batteries hardly be full charged simultaneously in light of each one's specific capacity, self-discharge, or decrements in the capacity etc, actually, always one or two batteries firstly approaches to full charged state. While such one or two continues to charge, due to an almost fully charged state is already appeared, those batteries could be overcharged. But, if not continue to charge fully, implementing powerful capacities of all batteries in series connection will not obtain higher output voltage.

### SUMMARY OF THE INVENTION

The present invention is to provide a lithium battery, a lithium phosphate based cathode is further added with, at least, an activated material has a voltage plateau larger than the lithium phosphate. When charged up, it desists from voltage of operating battery rising abruptly as total charge tolerance capacity being increased.

The lithium battery includes separators concentrically and intermittently encircled between laminated anode films and laminated cathode films, both of the cathode and anode films are also concentrically sandwiched by the separators; said cathode film includes an accumulation structure of lithium phosphate (LiFePO₄) added with, at least, an activated material has a voltage plateau larger than the lithium phosphate; said cathode films, anode films are intermittently and concentrically laminated with and sandwiched by separators further being rolled up to form a core installed inside a cylinder to form the battery.

Accordingly, batteries charging when batteries in serial connection, due to each one's capacity, decrement of capacity, self-discharge are quite different from one another; operating batteries could not be fully charged at the same time. Under such circumstance, usually an operating battery first charged in the serial connection allows to be charged to a nearly full voltage up to a threshold value at about 3.4 V earlier than others. At this time, once the battery only equipped with the lithium phosphate (LiFePO₄) based cathode, if not added with other activated materials, the first one charged battery connected in serial connection may continue to charge, according to a charge profile of lithium phosphate, the first charged battery may be overcharged. It means a capacity of the first battery is to be increased with an input voltage burst led to the first battery. But, an activated material has a voltage plateau larger than the lithium phosphate added to the accumulation structure, decreasing the charge rate further to avoid the first charged battery from being overcharged.

### BRIEF DESCRIPTION OF THE DRAWINGS

FIG. 1: a diagrammatic view of charge profile of the rated capacity and voltage of the first operating battery with lithium phosphate based cathode.

FIG. 2: a diagrammatic view of charge profile of the rated capacity and voltage of the first operating battery having lithium phosphate based cathode added with lithium-nickel-cobalt-manganese mixed metal oxide.

FIG. 3: a diagrammatic view of charge profile of the rated capacity and voltage of operating batteries with lithium phosphate based cathode in serial connection.

FIG. 4: a diagrammatic view of charge profile of the rated capacity and voltage of operating batteries with lithium phosphate based cathode added with lithium-nickel-cobalt-manganese mixed metal oxide in serial connection.

FIG. 5: a perspective view of a rolled up laminated cathode films, anode films, sandwiched by separators installed inside a cylinder to form a battery.

FIG. 6: a sectional view of a rolled up laminated films and separators.

FIG. 7: a diagrammatic view of laminated films and separators sealed in a near vacuum cylinder to form a battery.

### DETAILED DESCRIPTION OF THE PREFERRED EMBODIMENTS OF THE PRESENT INVENTION

Description of the present invention is described in detail according to the appended drawings hereinafter.

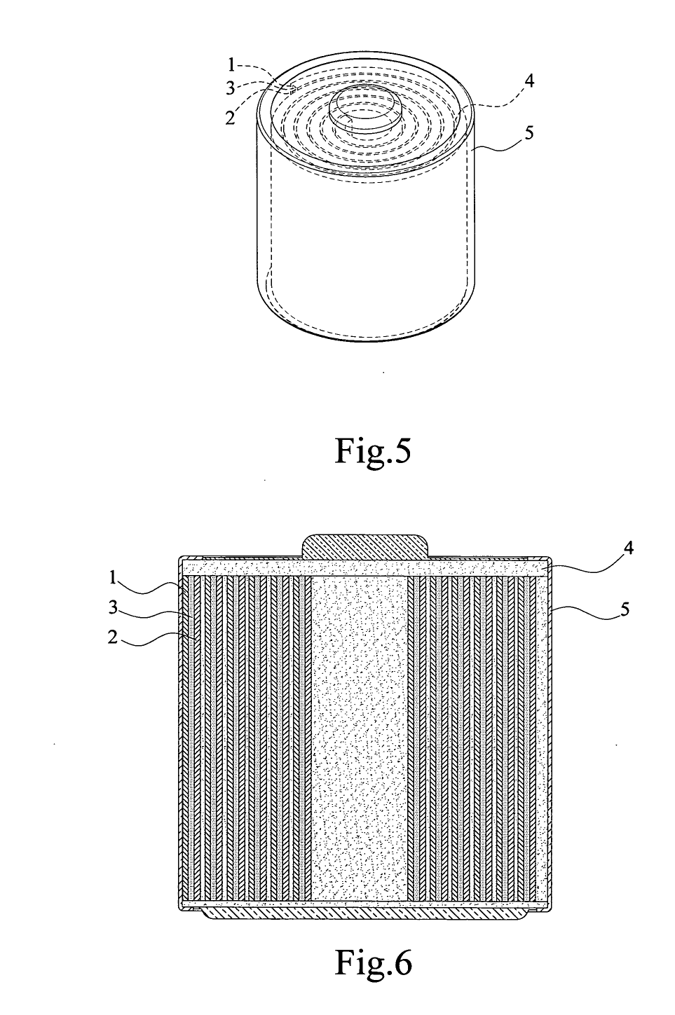

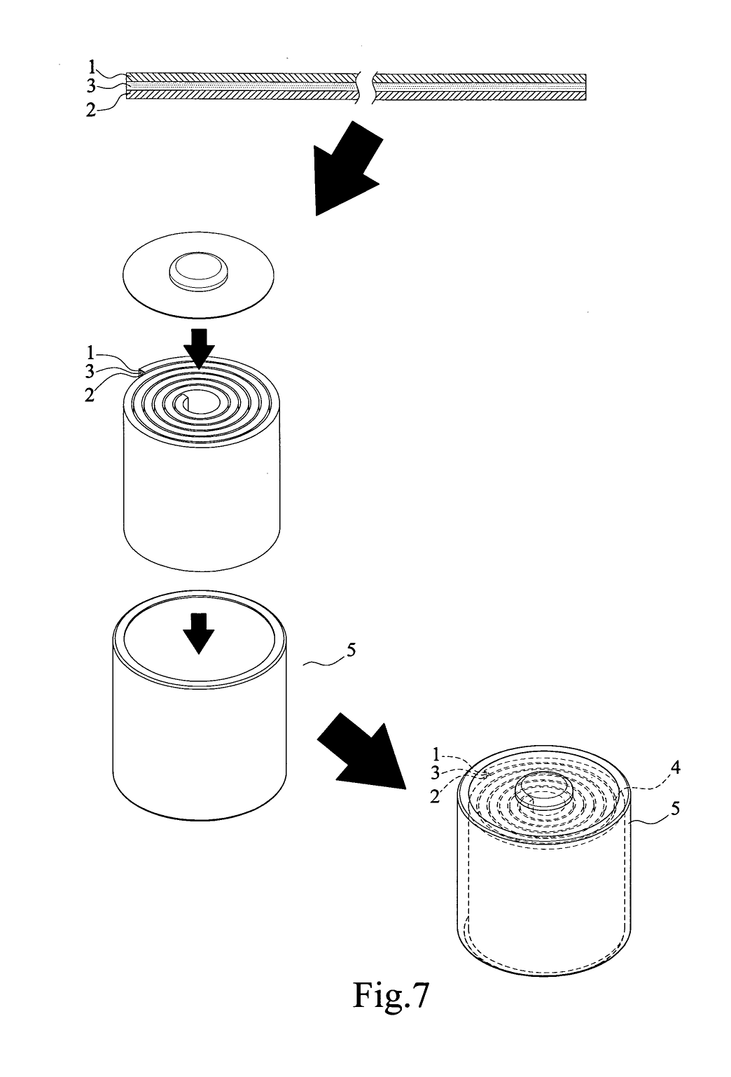

As shown in FIGS. 5-7, a lithium battery o f the present invention includes laminated cathode films (1), laminated anode films (2), and separators (3). Separators (3) are intermittently and concentrically encircled between laminated anode films (2) and laminated cathode films (1), both of the cathode and anode films (1,2) are also concentrically encircled with and sandwiched by the separators (3); said cathode film (1) includes an accumulation structure of lithium phosphate (LiFePO₄) added with, at least, an activated material has a voltage plateau larger than the lithium phosphate.

The activated material selected from but not limited to the materials as following: lithium-nickel-cobalt-manganese mixed metal oxide, lithium-nickel-cobalt-aluminum mixed metal oxide, lithium cobalt oxide, lithium manganese oxide, and lithium-nickel-manganese mixed metal oxide.

The laminated anode film (2) includes an accumulation structure added with anode activated materials. Porous composites of polypropylene and polyethylene can be adopted as separators, which are concentrically and intermittently encircled between the cathode film (1) and the anode film (2). Said cathode films (1) and anode films (2) further are sandwiched by the separators (3); those films (1, 2) and separators (3) are laminated layer by layer and rolled up to form a core to be installed inside a cylinder (5). The cylinder (5) is further filled with an electrolysis liquid (4) and to expel out air to a near-vacuum condition. Finally, the cylinder is sealed up to form a battery.

The lithium phosphate based cathode added with activated materials further incorporated into the cathode film, which comprises a weight ratio of 6 wt % (hereinafter wt %) conductive carbon added to the cathode film to conduct electricity, 5 wt % polyvinylidene chloride (PVDF) added to the cathode film as the cathode paste and 89 wt % activated material. About 89 wt %˜99.5 wt % activated materials is lithium phosphate, and it is preferably exemplified in the present invention by a middle value of 95 wt % in the range of 90 wt %-98 wt %. Lithium-nickel-cobalt-manganese mixed metal oxide added to the activated: material is preferably in the range of 0.5 wt %˜20 wt %. All the powdered materials as above mixed with N-methylpyrrolidone to form a cathode paste, which is further spread out on an aluminum foil at a breadth about 16 μm (10⁻⁶ m). The aluminum foil covered with the cathode paste, after being dried up, a cathode film (1) is achieved. The film coated with cathode paste is weighted as 0.12 g/cm², when impressed with impressions, a density of the coated film is increased up to 2.0 g/cm³. Consequently, as the coated film (1) is sliced and dimensioned in pieces, the cathode films (1) are achieved as required.

A binder of the anode film is provided with 93.5 wt % artificial graphite, 1.5 wt % carboxymethyl cellulose (CMC) and 3.0 wt % styrene-butadiene rubber (SBR) added with 2 wt % conductive carbon as conductor. All powdered materials as above mixed with water and stirred to form an anode paste, which is spread out evenly on a copper foil of 9 μm (10⁻⁶ m) breadth, after drying up, the coated film (2) is achieved. The film coated with anode paste is weighted as 0.06 g/cm2, when impressed with impressions, a density of the coated film is about 1.4 g/cm3, as the coated film (2) is sliced and dimensioned in pieces, the anode films (2) are achieved as required.

The anode films (2) and the cathode films (1) are sandwiched by the separators (3), which is concentrically and intermittently encircled with the anode film (2) and the cathode film (1) together further being rolled up to form a core. The core is installed inside a cylinder (5) of a battery. The cylinder (5) is filled with the electrolysis liquid (4). The electrolysis liquid (4) containing lithium hexafluorophosphate (LiPF₆) as a lithium salt, and a solvent comprises 40 wt % ethylene carbonate, 30 wt % ethyl methyl carbonate (EMC), and 30 wt % dimethyl carbonate. The solvent (4) is not mixed with water. After forcing out air from the cylinder (5), which is further sealed up to form a battery.

Tests on Charging Rates:

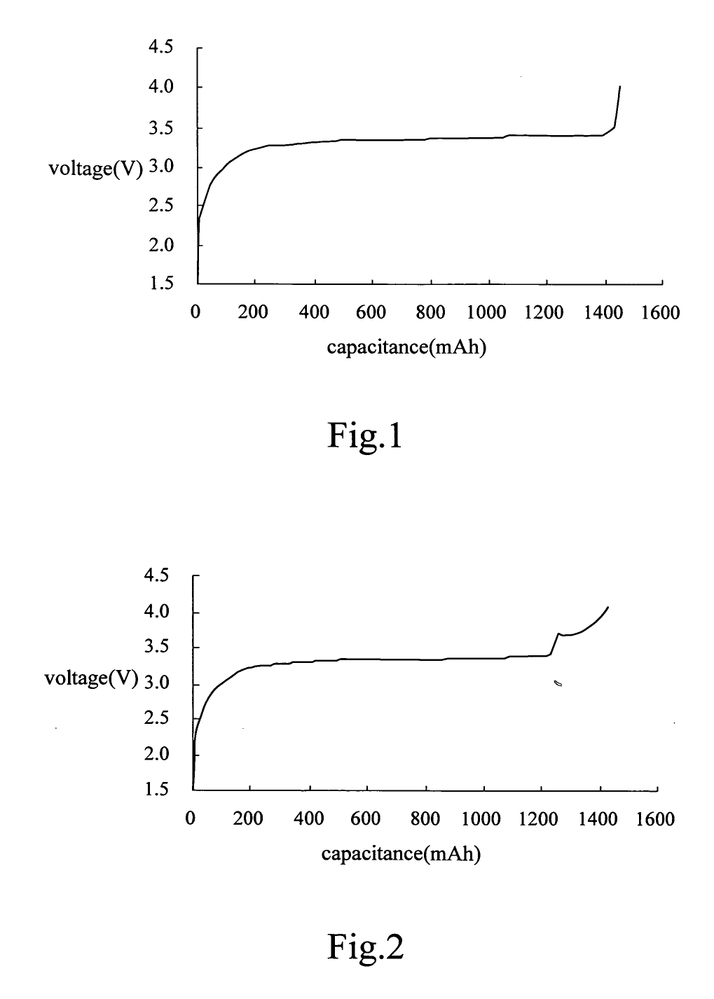

Test 1 in comparison with (A): a battery equipped with the lithium phosphate based cathode, and (B): a battery equipped with the lithium phosphate based cathode added with lithium-nickel-cobalt-manganese mixed metal oxide; both of them are separately tested by charge cycle. A charged source voltage is in the range of 2.0 V-3.8 V. When charging up, a test battery is charged by a stable current of 30 Ampere hour (Ah) to charge fully to an input voltage up to 3.8 V, after that, the test battery is charged by only a current of 0.5 Ah. Test out the test battery is already charged with a voltage of 3.8 V, charging will come to a halt. When discharging, the test battery is discharged by a current of 80 Ah to discharge to 2.0 V, after that, when the test battery is further discharged to 1.5 V. Discharging will come to a halt. Charge profiles are illustrated as shown in FIG. 1 and FIG. 2. In FIG. 1, when the test battery is approaching nearly full charged, voltage of the battery rising to the maximum allowable voltage of the charged source as long as a total charge tolerance capacity reached. In FIG. 2, as the test battery is equipped with the lithium phosphate based cathode added with lithium-nickel-cobalt-manganese mixed metal oxide, decreasing the charge rate further to avoid the first charged battery from being overcharged.

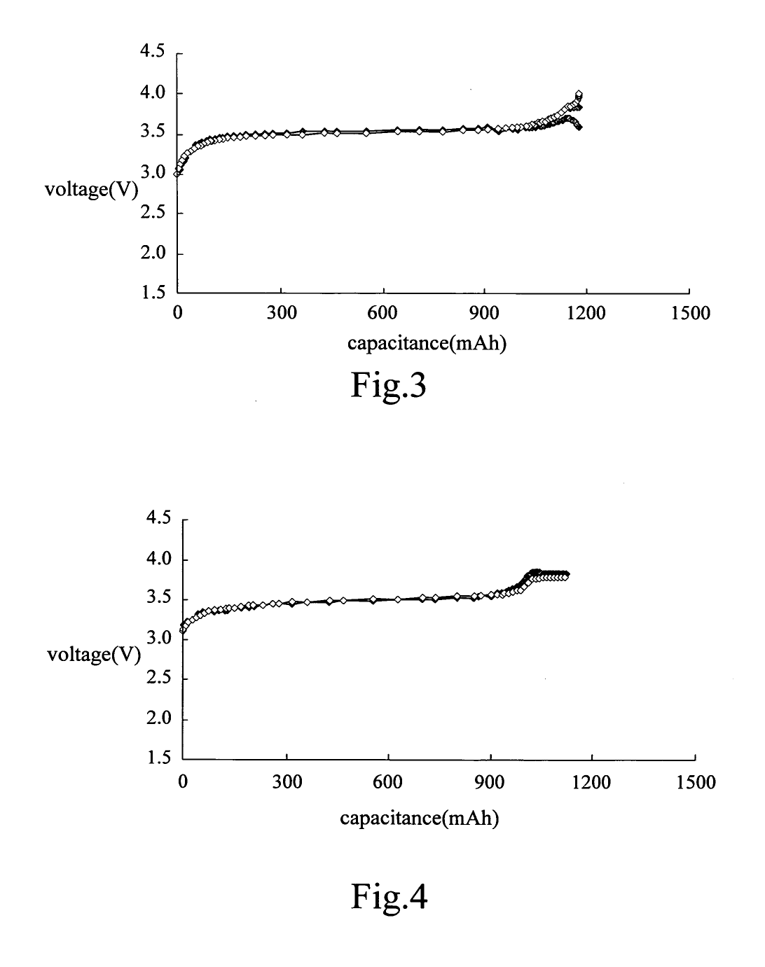

Test 2 in comparison with (A) three test batteries equipped with lithium phosphate based cathodes in serial connection, and (B) three batteries equipped with the lithium phosphate based cathode added with lithium-nickel-cobalt-manganese mixed metal oxide; both of them are separately tested by charge cycle. A charged source voltage is in the range of 6.0 V-11.4 V in total, but each of the test batteries is charged by a charged source separately in the range of 1.5 V-4.0 V. When charging up, test batteries are charged by a stable current of 30 Ampere hour (Ah) to charge fully to an input voltage up to 11.4 V in total, after that, the test batteries are charged by only a current of 0.5 Ah. Test out the first charged test battery is already charged with a voltage of 4.0 V, charging will come to a halt. When discharging, the test batteries are discharged by a current of 80 Ah to discharge to 6.0 V in total, after that, when the first discharged test battery is further discharged to a voltage lower than 1.5 V. Discharging will come to a halt. Charge profiles are illustrated as shown in FIG. 3 and FIG. 4. In FIG. 3, a tolerance of initial charge capacity of the first charged fully lithium phosphate based battery is about 10 milliampere hour (mAh); thereby, the test battery is easily overcharged in initial charge cycles. In FIG. 4, each of the test batteries equipped with the lithium phosphate based cathode added with lithium-nickel-cobalt-manganese mixed metal oxide are fully charged with a voltage about 4.0 V to decrease the charge rate.

What is claim claimed:

1. A lithium battery comprising cathode films, anode films, and separators; said cathode film includes a cathode accumulation structure of lithium phosphate (LiFePO₄); said anode film includes an anode accumulation structure added with an anode activated material; said separators concentrically and intermittently encircled between laminated anode films and laminated cathode films, both of the cathode and anode films are also concentrically sandwiched by the separators; characterized in that: said cathode films added with, at least, a cathode activated material has a voltage plateau larger than the lithium phosphate.

2. The lithium battery of claim 1 wherein said cathode activated materials selected from but not limited to the materials as following: lithium-nickel-cobalt-manganese mixed metal oxide, lithium-nickel-cobalt-aluminum mixed metal oxide, lithium cobalt oxide, lithium manganese oxide, and lithium-nickel-manganese mixed metal oxide.

3. The lithium iron battery of claim 2 wherein a weight ratio in the range of 80 wt %˜99.5 wt % (hereinafter wt %) of said cathode activated material is lithium phosphate.

4. The lithium iron battery of claim 3 wherein a weight ratio of lithium ion phosphate incorporated into the cathode activated material is preferably in the range of 90 wt %-98 wt %.

5. The lithium iron battery of claim 1 wherein said cathode activated materials includes lithium phosphate and lithium-nickel-cobalt-manganese mixed metal oxide.

6. The lithium iron battery of claim 5 wherein a weight ratio of lithium phosphate incorporated into the cathode activated material is in the range of 80 wt %˜99.5 wt %.

7. The lithium iron battery of claim 6 wherein a weight ratio of lithium phosphate incorporated into the cathode activated material is preferably in the range of 90 wt %-98 wt %.

8. The lithium iron battery of claim 1 wherein the activated material of the anode film is artificial graphite.
